(19) United States
(12) Patent Application Publication
(10) Pub. No.: US 2026/0184479 A1
(43) Pub. Date: Jul. 2, 2026

(54) SAMPLE STORAGE CONTAINER

(71) Applicant: MAPLE LS CORPORATION, Hongcheon-gun, Gangwon-do (KR)

(72) Inventor: YUN PARK, Seoul (KR)

(73) Assignee: MAPLE LS CORPORATION, Hongcheon-gun, Gangwon-do (KR)

(21) Appl. No.: 18/844,396

(22) PCT Filed: Mar. 15, 2023
(86) PCT No.: PCT/KR2023/003476

§ 371 Date: Sep. 6, 2024

(30) Foreign Application Priority Data
Mar. 3, 2023 (KR) 10-2023-0028167

(51) Int. Cl. B65D 51/00; B01L 3/00

(52) U.S. Cl. CPC B65D 51/002; B01L 3/508; B01L 2200/12; B01L 2300/042; B01L 2300/044; B01L 2300/12; B01L 2300/123

(57) ABSTRACT

A sample storage container includes: a collection container having an open top; a cap which opens and closes the top of the collection container; and a membrane which is situated at the center of the cap and is made of a different material from the cap, and through which a needle or a pipette tip of a collection tool penetrates.

### CROSS-REFERENCE TO PRIOR APPLICATIONS

This application is a National Stage Patent Application of PCT International Application No. PCT/KR2023/003476 (filed on Mar. 15, 2023), which claims priority to Korean Patent Application No. 10-2023-0028167 (filed on Mar. 3, 2023), which are all hereby incorporated by reference in their entirety.

### BACKGROUND

The present disclosure relates to a sample storage container, and more specifically, to a sample storage container that allows for the injection of a sample into a collection container without separating a cap from the collection container, and prevents the sample from being contaminated by blocking external air from entering the inside of the collection container.

In general, sample storage containers are commonly used in hospitals or laboratories for temporarily storing a tester's blood after collecting a blood sample for various disease tests or blood alcohol concentration tests. Such a conventional sample storage container includes a sterilized collection container that accommodates a sample and a cap that is coupled to an open part of the collection container.

The cap of the sample storage container is designed to be simply inserted or screw-coupled onto the open part at the top of the collection container. The coupling structure that the cap is inserted is simple in opening and closing operations compared to a screw-coupling structure, but has a problem in that foreign matters may be introduced or blood leakage may occur during the transportation due to deteriorated sealability.

As described above, the cap coupled to the open part of the collection container is typically molded from a single material of thermoplastic resin, such as polypropylene, which has excellent chemical resistance. However, in case of the structure inserted or screw-coupled into the open part of the collection container, in order to collect the sample and put the sample into the collection container, there is an inconvenience as the cap must be removed from the collection container, and then, applied to the collection container after the insertion of the sample into the collection container.

Furthermore, in order to insert a sample collected via a syringe or similar collection tool into the collection container, a user must first detach the cap from the collection container, insert the syringe needle into the collection container, inject the sample into the collection container, and then reattach the cap to the collection container. So, contaminants may be introduced into the collection container during the opened state of the cap, or the inside of the collection container may be contaminated while the detached cap in a contaminated state is coupled to the collection container.

### SUMMARY

Accordingly, the present invention has been made in view of the above-mentioned problems occurring in the related art, and it is an object of the present invention to provide a sample storage container that allows for the injection of a sample into a collection container without separating a cap from the collection container, and prevents the sample from being contaminated by blocking external air from entering the inside of the collection container.

To accomplish the above-mentioned objects, according to the present invention, there is provided a sample storage container including: a collection container having an open top; a cap which opens and closes the top of the collection container; and a membrane which is situated at the center of the cap and is made of a different material from the cap, and through which a needle or a pipette tip of a collection tool penetrates.

Here, the cap is formed by insert injection molding such that the membrane is interposed in a mold.

Moreover, the cap is made of polypropylene, and the membrane is made of elastomer.

Furthermore, the cap has a plurality of uneven portions formed on the inner diameter contacting the membrane and the membrane is embedded between the uneven portions.

Additionally, the membrane has a concave portion that the upper surface is dented toward the inside of the collection container.

In addition, the membrane has a cut line formed on the upper surface thereof.

Moreover, it is preferable that the membrane is formed in a hollow conical shape.

Furthermore, it is preferable that the membrane has a nipple on the surface facing the inside of the collection container.

Additionally, it is preferable that the membrane has a cut line formed on the upper surface of the membrane, wherein the cut line is directed towards the nipple.

Moreover, it is preferable that the membrane is double-formed at the center of the cap.

Furthermore, it is preferable that a hollow is formed between the membrane double-formed at the center of the cap.

According to an embodiment of the present invention, the sample storage container is provided with the membrane, which is provided at the center of the cap opening and closing the open portion of the collection container and is made of an elastomer having elasticity so that the user can inject the sample into the collection container by boring the membrane with the needle or the pipette tip of the collection tool, thereby allowing the user to inject the sample into the collection container without detaching the cap from the collection container and moving the sample into the collection container easily.

In addition, According to an embodiment of the present invention, after the injection of the sample into the collection container is complete, as soon as the needle or the pipette tip of the collection tool is pulled out of the collection container, the membrane made of elastomer shows elastic force to block the bored membrane, thereby blocking external air from entering the collection container and preventing contamination of the sample.

### BRIEF DESCRIPTION OF THE DRAWINGS

FIG. 1 is a sectional view of a sample storage container according to an embodiment of the present invention.

FIG. 2 is a sectional view illustrating the sample storage container being penetrated by a collection tool according to the present invention.

FIG. 3 is a sectional view illustrating a cut line formed on a membrane of the sample storage container according to the present invention.

FIGS. 4 to 8 are sectional views illustrating a membrane of the sample storage container according to another embodiment of the present invention.

### DETAILED DESCRIPTION

The terms and words used in the specification and claims must not be limited to typical or dictionary meanings, but must be regarded as concepts selected by the inventor as concepts which best illustrate the present invention, and must be interpreted as having meanings and concepts adapted to the scope and spirit of the present invention to aid in understanding the technology of the present invention.

Hereinafter, preferred embodiments of the present invention will be described in detail with reference to the accompanying drawings.

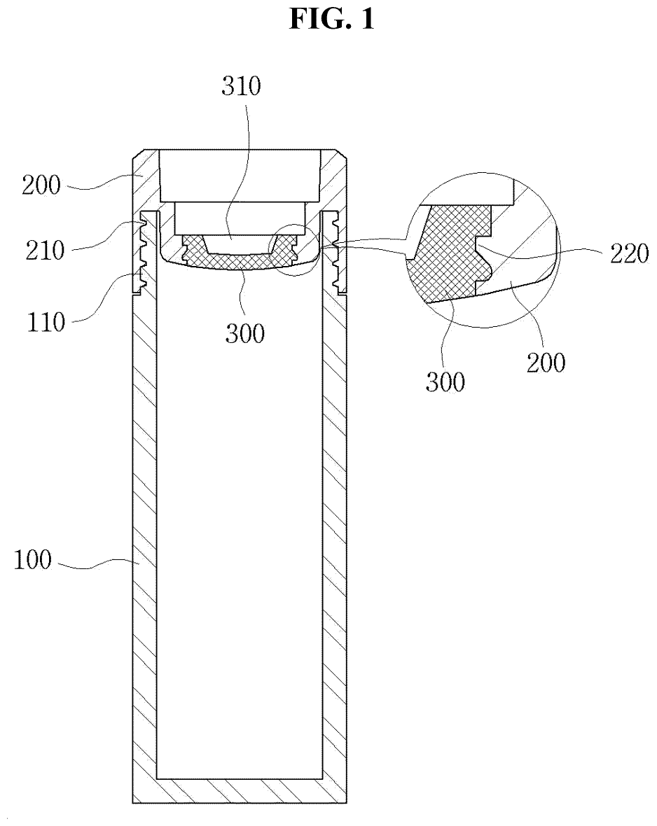

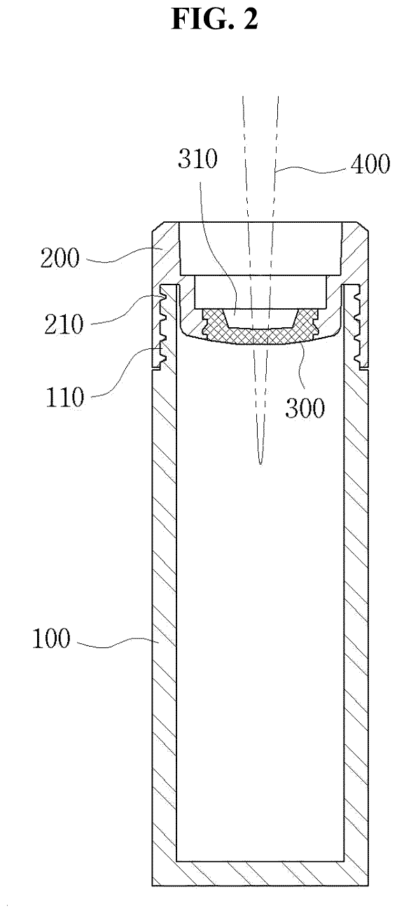

FIG. 1 is a sectional view of a sample storage container according to an embodiment of the present invention, and FIG. 2 is a sectional view illustrating the sample storage container being penetrated by a collection tool according to the present invention.

Referring to the drawings, the sample storage container according to an embodiment of the present invention includes: a collection container 100 having an open top; a cap 200 which opens and closes the top of the collection container 100; and a membrane 300 which is situated at the center of the cap 200 and is made of a different material from the cap 200, and through which a needle or a pipette tip 400 of a collection tool penetrates.

Additionally, the collection container 100 has a space for accommodating the sample therein, and is designed as a container with an open top so that the sample can be introduced through the open top. Moreover, the collection container 100 is made of a transparent or translucent material enabling the identification of the presence or absence of the sample from the outside.

The collection container 100 is made of a thermoplastic resin such as polypropylene, which has excellent chemical resistance, and has a male screw 110 which is formed on the outer diameter of the top of the collection container 100 to be screw-coupled with the cap 200 to seal the collection container.

The cap 200 coupled to the top of the collection container 100 has a cylindrical shape with a female screw 210 formed on the inner surface thereof to be screw-coupled with the male screw 110 formed on the top of the collection container 100. The outer circumferential surface of the cap 200 is formed in a polygonal shape so that a user can detach the cap from the collection container by rotating the cap or has a non-slip portion like a minute slit formed along the outer circumferential surface of the cap 200. The cap 200 is also made of a thermoplastic resin such as polypropylene, with the excellent chemical resistance.

Moreover, the cylindrical cap 200 has a membrane 300 which is provided at the center thereof and is made of a material different from that of the cap 200. The membrane 300 is preferably made of an elastomer, which exhibits rubber elasticity at room temperature, and is penetrated by a collection tool, such as a needle or a pipette tip 400.

The cap 200 having the membrane 300 is molded by insert injection molding, where the membrane 300 is placed in a mold such that the cap 200 and the membrane 300 are integrally formed.

As described above, when the cap and the membrane 300 are molded by the insert injection molding so that the membrane 300 is provided at the center of the cap 200, to locate the membrane 300 at the center of the cap 200 in a firm state, as illustrated in a circle of FIG. 1, the cap 200 has a plurality of uneven portions 220 formed on the inner diameter contacting the membrane 300 and the membrane 300 is embedded between the uneven portions 220.

As described above, when the uneven portions 220 are formed on the inner diameter of the cap 200 and the membrane 300 is embedded between the uneven portions 220, the coupling between the cap 200 and the membrane 300 can be solidified more. So, when the user presses the membrane 300 with the needle or the pipette tip 400 of the collection tool to penetrate through the membrane, it is prevented that the membrane 300 is separated from the cap 200.

Moreover, the membrane 300 has a concave portion 310 that the upper surface is dented toward the inside of the collection container 100. Due to the concave portion 310 formed on the upper surface of the membrane 300, the user bores the membrane 300 with the needle or the pipette tip 400 of the collection tool to inject the sample of the collection tool into the collection container 100, the tip of the needle or the pipette tip 400 of the collection tool is guided to the center of the membrane 300, so that the user can stably bore the membrane 300 with the needle or the pipette tip 400 of the collection tool.

As described above, since the membrane 300 made of elastomer unlike the cap 200 made of polypropylene is provided at the center of the cap 200, as illustrated in FIG. 2, there is no need to separate the cap 200 from the collection container 100 to put the sample into the collection container. That is, the membrane 300 provided in the cap 200 is bored with the needle or the pipette tip 400 of the collection tool, the tip of the needle or the pipette tip 400 of the collection tool is inserted into the collection container 100, and then, the sample is injected into the collection container 100.

When the injection of the sample is completed, the needle or the pipette tip 400 of the collection tool inserted into the collection container 100 is drawn out of the collection container. In this instance, as soon as the needle or the pipette tip 400 of the collection tool penetrating through the membrane 300 is pulled out, the membrane 300 made of elastomer shows elasticity, so that a hole formed by the needle or the pipette tip 400 of the collection tool is blocked, thereby allowing the sample to be conveniently moved into the collection container without detaching the cap 200.

Furthermore, as described above, since the membrane 300 is made of elastomer and the hole formed by the needle or the pipette tip 400 of the collection tool is blocked as soon as the needle or the pipette tip 400 of the collection tool is pulled out, it is prevented that external air enters the collection container 100 and the sample introduced into the collection container 100 is contaminated.

Meanwhile, the present invention is not limited to the embodiments described above and can be modified and varied without departing from the gist of the present invention, and it should be understood that such modifications and variations belong to the technical spirit of the present invention.

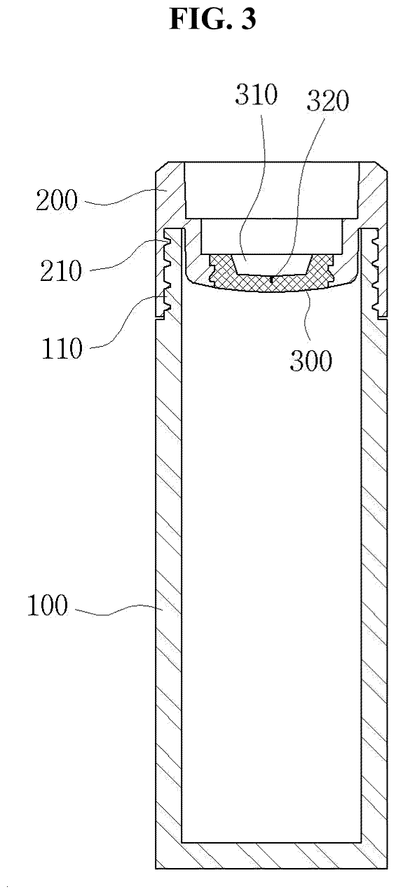

For example, as illustrated in FIG. 3, the membrane 300 has a cut line 320 formed on the upper surface thereof. The cut line 320 formed on the membrane 300 is formed in such a way as to be partially cut from the upper surface to the lower surface of the membrane 300.

Moreover, the cut line 320 formed on the upper surface of the membrane 300 can be shaped in a linear or cross pattern when viewed from above the cap 200, thereby enhancing the visibility for the user to easily position the tip of the needle or pipette tip 400 on the upper surface of the membrane 300.

As described above, due to the cut line 320 formed on the upper surface of the membrane 300, the user can bore the membrane 300 with the needle or pipette tip 400 of the collection tool without much effort to inject the sample into the collection container 100, thereby facilitating the introduction of the needle or pipette tip 400 into the interior of the collection container 100.

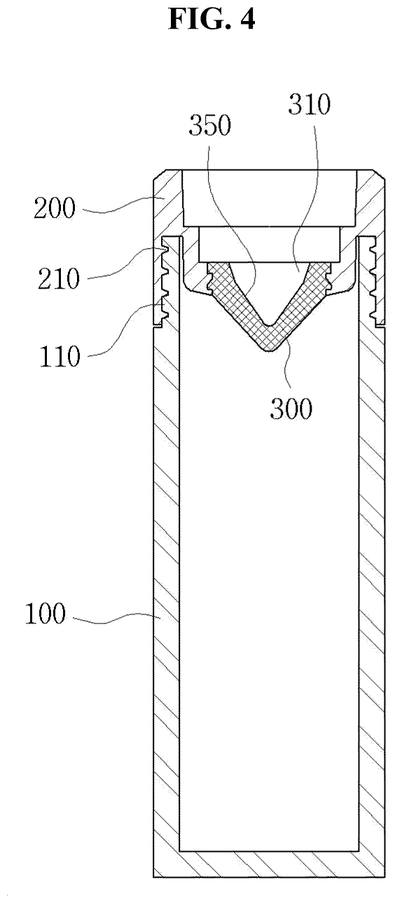

Furthermore, as illustrated in FIG. 4, the membrane 300 can be formed in a hollow conical shape. As described above, since the membrane 300 has the hollow conical shape and the apex of the membrane 300 is positioned inside the collection container 100, when the user inserts the needle or pipette tip 400 of the collection tool into the collection container 100, the needle or pipette tip 400 of the collection tool is guided to the apex of the membrane 300 while sliding along an inclined surface 350 of the membrane 300 having the hollow conical shape so that the needle or pipette tip 400 of the collection tool can penetrate the center of the membrane 300, thereby preventing the needle or pipette tip 400 of the collection tool from being obstructed by the cap 200 not to be inserted into the collection container 100.

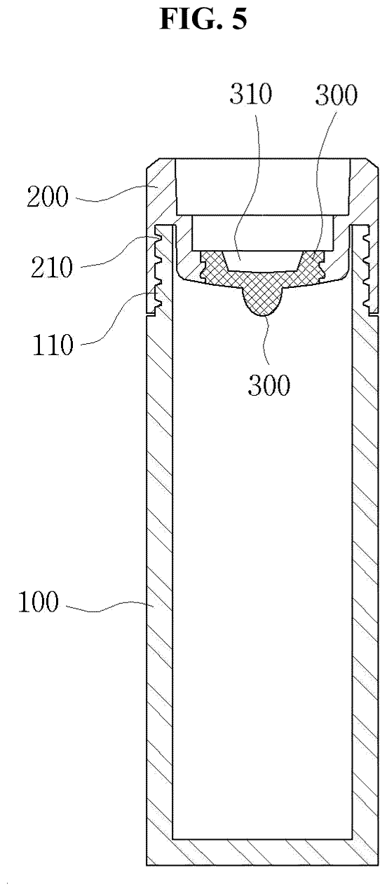

Additionally, as illustrated in FIG. 5, the membrane 300 has a nipple 330 formed on the lower surface of the membrane 300 facing the interior of the collection container 100. Due to the nipple 330 formed on the lower surface of the membrane 300, when the needle or pipette tip 400 of the collection tool penetrates through the membrane 300, a penetration section of the needle or pipette tip 400 of the collection tool is increased, thereby increasing a contact area between the membrane 300 and the needle or pipette tip 400 of the collection tool.

As described above, when the contact area between the membrane 300 and the needle or pipette tip 400 of the collection tool is increased, while the needle or pipette tip 400 of the collection tool penetrates through the membrane 300, it can be minimized that external air enters the collection container 100 through a space between the membrane 300 and the needle or pipette tip 400 of the collection tool, thereby preventing contamination of the sample.

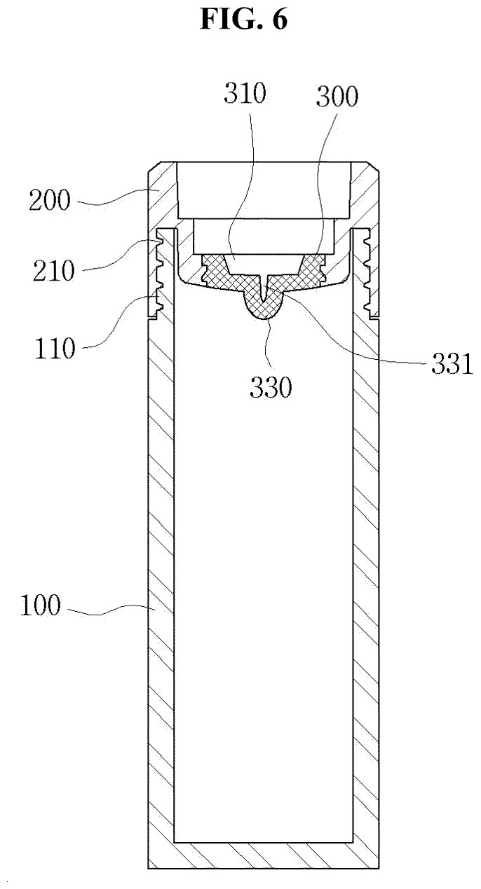

In addition, when the nipple 330 is formed on the membrane 300, as illustrated in FIG. 6, a cut line 331 may be formed on the upper surface of the membrane. So, when the cut line 331 is formed on the membrane 300 having the nipple 330, the cut line 331 is formed on the upper surface of the membrane toward the nipple 330.

As described above, since the nipple 330 and the cut line 331 are formed on the membrane 300, the user can bore the membrane 300 with the needle or pipette tip 400 of the collection tool without much effort to inject the sample into the collection container 100, and a portion of the cut portion of the membrane 300 gets in contact with the needle or pipette tip 400 of the collection tool to minimize the introduction of the external air into the collection container 100, thereby preventing contamination of the sample.

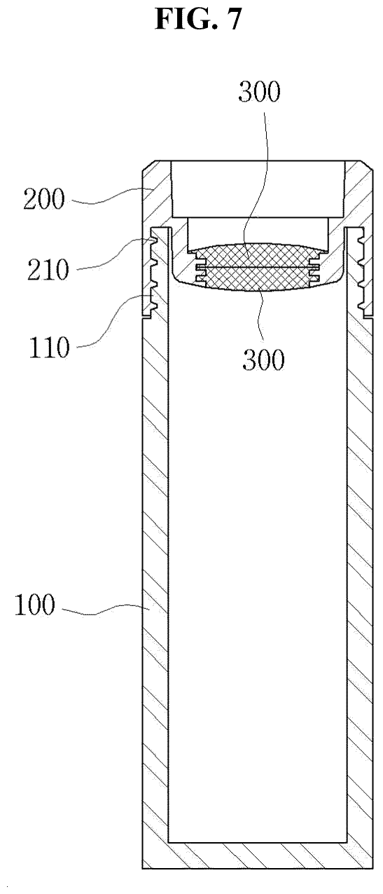

Moreover, as illustrated in FIG. 7, the cap 200 can be equipped with double-layered membranes 300 at the center thereof. In this configuration, the double-layered membranes 300 of the cap 200 are stacked at the center of the cap 200. Due to the double-layered membranes 300, even if external force is applied to the membrane 300 located outside the cap 200 and the membrane is damaged and fails to function properly, the membrane 300 located inside the cap 200 is protected by the outer membrane 300, thereby being prevented against damage.

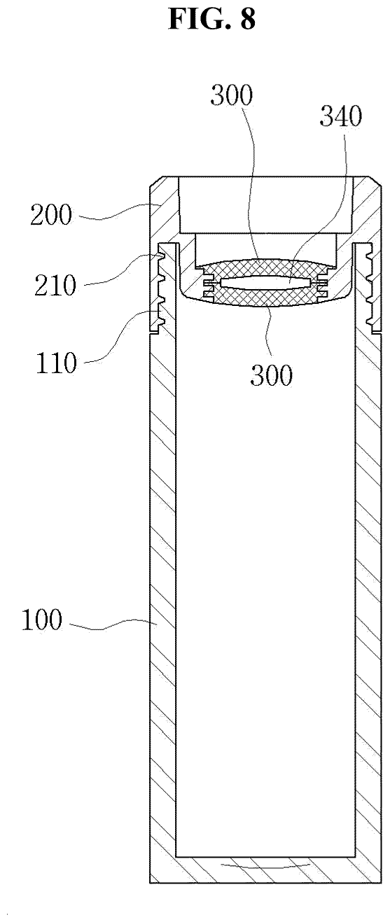

In addition, in case of the double-layered membranes 300, as illustrated in FIG. 8, a hollow space 340 can be formed between the membranes 300. Due to the hollow space 340 formed between the double-layered membranes 300 within the cap 200, when external force is applied to the outer membrane 300, the hollow space 340 buffers the external force so that the external force is not directly transferred to the inner membrane 300, thereby preventing damage to the inner membrane 300.

** Explanation of Reference Numbers **

| | |
|---|---|
| 100: Collection container | 110: Male screw |
| 200: Cap | 210: Female screw |
| 220: uneven portion | 300: Membrane |
| 310: Concave part | 320: Cut line |
| 330: Nipple | 331: Cut Line |
| 340: Hollow space | 350: Inclined surface |
| 400: Needle or pipette tip of collection tool | |

1. A sample storage container comprising:
a collection container having an open top;
a cap which opens and closes the top of the collection container; and
a membrane which is situated at the center of the cap and is made of a different material from the cap, and through which a needle or a pipette tip of a collection tool penetrates.

2. The sample storage container according to claim 1, wherein the cap is formed by insert injection molding such that the membrane is interposed in a mold.

3. The sample storage container according to claim 1, wherein the cap is made of polypropylene, and the membrane is made of elastomer.

4. The sample storage container according to claim 1, wherein the cap has a plurality of uneven portions formed on the inner diameter contacting the membrane and the membrane is embedded between the uneven portions.

5. The sample storage container according to claim 1, wherein the membrane has a concave portion that the upper surface is dented toward the inside of the collection container.

6. The sample storage container according to claim 1, wherein the membrane has a cut line formed on the upper surface thereof.
